(19) United States
(12) Patent Application Publication
(10) Pub. No.: US 2018/0171084 A1
(43) Pub. Date: Jun. 21, 2018

(54) ADHESION PROMOTER

(71) Applicant: PPG Industries Ohio, Inc., Cleveland, OH (US)

(72) Inventors: Lorraine Hsu, Pittsburgh, PA (US); Wei Wang, Allison Park, PA (US); Tyler Gregorchik, Pittsburgh, PA (US); Robert W. White, Gibsonia, PA (US); Chinming Hui, Gibsonia, PA (US); John Weijnen, Alphen aan den Rijn (NL); Yu Wang, Pittsburgh, PA (US); Stephen John Thomas, Aspinwall, PA (US); Lan Deng, Pittsburgh, PA (US)

(21) Appl. No.: 15/848,030

(22) Filed: Dec. 20, 2017

Related U.S. Application Data
(60) Provisional application No. 62/437,234, filed on Dec. 21, 2016.

(51) Int. Cl. C08J 5/12; C08L 33/08; C08L 33/10; C08L 83/04; C08L 23/00; C09J 123/02

(52) U.S. Cl. CPC C08J 5/124; C08L 33/08; C08L 33/10; C08L 2205/08; C08L 23/00; C09J 123/02; C08L 83/04

(57) ABSTRACT

Disclosed is a resinous adhesion promoter composition comprising a random copolymer having first and second constitutional monomeric units, the first monomeric units comprising functional groups that promote adhesion to a substrate and the second monomeric units being derived from ethylenically unsaturated monomers and comprising other functional groups that promote adhesion to a substrate.

### CROSS REFERENCE TO RELATED APPLICATIONS

This application claims the benefit of U.S. Provisional Application No. 62/437,234 filed Dec. 21, 2016, which is incorporated herein by reference in its entirety.

### FIELD OF THE INVENTION

The present invention relates to coating compositions having adhesion to various types of substrates.

### BACKGROUND OF THE INVENTION

Materials used in a wide variety of manufactured articles for use in the automotive, industrial, and appliance markets, among others, are often desirably coated with decorative and/or protective coating compositions. Such materials may be metallic, ceramic, polymeric, wooden or the like. Others may be previously coated with a coating composition, such as an alkyd-based paint and adhesion of coatings applied over such previously applied paint can be problematic. Vehicles, for example, include many interior and exterior parts and attachments that are constructed from polymers, such as mirror casings, fenders, bumper covers, spoilers, dashboards, interior trim, and the like. Such articles generally are prepared by molding an article from a polyolefin or other resin and applying to the molded article one or more film-forming coating layers to protect and/or color the article. One of the difficulties associated with the use of polymeric substrates is that typical film-forming compositions used for protective and/or decorative coatings may not adhere. In refinishing molded articles constructed from polymers, for example, addition of an adhesion promoting layer can make the refinishing process complex, time-consuming, and expensive. Coatings and methods to reduce this time and complexity are therefore desired. In order to improve the adhesion the plastic substrates are conventionally specifically pretreated, e.g. by sanding the substrates or wiping the substrates with an adhesion promoter such as chlorinated polyolefin (CPO).

Certain prior art adhesion promoting layers were not suitable as protective and/or decorative coatings. Enhanced adhesion of coating compositions to various substrates (metallic, ceramic, polymeric, wooden and/or previously coated) is desired.

### SUMMARY OF THE INVENTION

The present invention includes a resinous adhesion promoter composition comprising a random copolymer having first and second constitutional monomeric units, the first monomeric units comprising functional groups that promote adhesion directly or indirectly to a substrate and the second monomeric units comprising being derived from ethylenically unsaturated monomers and comprising other functional groups that promote adhesion to a substrate. The present invention includes a substrate at least partially coated with the afore-described resinous adhesion promoter layer.

The invention also includes a method of treating a substrate comprising (1) cleaning at least a portion of a substrate, and (2) applying a resinous adhesion promoter composition as defined above directly onto the cleaned portion, wherein step (2) directly follows step (1) with no steps in between.

### DESCRIPTION OF THE INVENTION

For the purposes of the following detailed description, it is to be understood that the invention may assume various alternative variations and step sequences, except where expressly specified to the contrary. It is also to be understood that the specific compositions, coated substrates, multilayer coatings and methods described in the following specification are simply exemplary embodiments of the invention. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The present invention is generally directed to resinous adhesion promoter compositions also referred to as coating compositions having adhesion to substrates. Phrases such as “having adhesion” or “promote adhesion” or the like in reference to a composition refer to a feature of that composition that reduces, if not avoids, delamination of a film-forming composition or film formed therefrom from a substrate, and phrases such as “adhesion promoter” refer to a component that, when included in a composition, promotes adhesion of the composition to a substrate. The present coating compositions generally comprise a random copolymer as an adhesion promoter, wherein one type of the monomeric units of the random copolymer comprises halogen and/or a pendant organic group having six or more carbon atoms and another type of monomeric units of the random copolymer comprises an active hydrogen-containing functional group. Methods of treating and/or coating polymeric substrates using these coating compositions are also within the scope of the present invention.

Reference is made herein to a random copolymer composed of at least two types of monomeric units. In the context of the present invention the phrases “constitutional monomeric units”, “constituting monomeric units” or “monomeric units” are used to designate the basic structural units associated to each other by covalent bonds to form the polymer chain being derived from polymerization of the respective unsaturated monomers. By random polymer it is meant that the different constituting monomeric units are distributed along the polymer chain in a random order as opposed to block copolymers, wherein the different types of monomeric units are arranged blockwise. The random copolymer can have any number of different types of constituting monomeric units (at least two) and any number of monomer units. The random copolymer may have a number average molecular weight (Mn) of at least 1,000 g/mol and up to 10,000 g/mol or up to 20,000 g/mol as measured by gel permeation chromatography using polystyrene standards.

As used herein, “(meth)acrylate” and like terms refers both to the acrylate and the corresponding methacrylate. The terms “resin” and “resinous” and like terms are used interchangeably with “polymer” and “polymeric” and the like. Further, the term “polymer” refers to oligomers and homopolymers (e.g., prepared from a single monomer species), copolymers (e.g., prepared from at least two monomer species), polymers prepared with more than two, such as three or more, monomer species, and graft polymers.

A resinous adhesion promoter composition according to the present invention comprises a random copolymer having at least first and second types of monomeric units. The first monomeric units comprise functional groups that promote adhesion to a substrate, such as a halogen substituent and/or a pendant organic group having six or more carbon atoms. The second monomeric units are derived from ethylenically unsaturated monomers and include other functional groups (different from the functional groups of the first monomeric units) that promote adhesion to a substrate. The resinous adhesion promoter composition according to the present invention may further comprise (i) a non-reactive adhesion promoter and/or (ii) a reaction mixture comprising a first component and a second component, at least one of the first and second components having functional groups being reactive with groups of the random copolymer. It will be appreciated, therefore, that the random copolymer is capable of reacting with the first and/or second component.

The first monomeric units of the random copolymer comprise as set forth above a halogen substituent and/or a pendant organic group having six or more carbon atoms. The first monomeric units are included in the copolymer to promote adhesion to a polymeric substrate. The halogen substituent may be Cl or any of F, Cl, Br, and I. The pendant organic group can have for example from 6 to 20 carbon atoms such as from 8 to 18 carbon atoms. It can be a hydrocarbon group such as an alkyl, cycloalkyl, aryl, aralkyl, alkylcycloalkyl or alkylaryl group or include one or more heteroatom(s) (meaning atoms different from C and H) such as e.g. oxygen or nitrogen. The first monomeric units can be derived from respective ethylenically unsaturated monomers used in the preparation of the copolymer. As used herein, “ethylenically unsaturated” refers to a group having at least one carbon-carbon double bond. Thus, the first monomeric units can be derived from one or more than one ethylenically unsaturated monomer having one or more halogen atom and/or one or more organic substituent having six or more carbon atoms. Suitable monomers include for example, without being limited thereto, fatty acids or esters or amides of unsaturated acids such as acrylic acid or (alkyl)acrylic acids, e.g. (meth)acrylic acid (esters or amides of acrylic acid and/or of methacrylic acid being referred to herein collectively as “(meth)acrylates” or (meth)acrylamides, respectively) with a C6+ organic group bound via the ester bond or as N-bound substituent. Such ester monomers can be exemplified without being limited thereto by alkyl(meth)acrylate, cycloalkyl(meth)acrylate, alkylcyclo(meth)acrylate, aralkyl(meth)acrylate, alkylaryl(meth)acrylate or aryl(meth)acrylate monomers or heteroatom-containing derivatives thereof, such as isobornyl(meth)acrylate, isodecyl(meth)acrylate, lauryl(meth)acrylate, tridecyl(meth)acrylate, tetradecyl(meth)acrylate, hexadecyl(meth)acrylate, octadecyl(meth)acrylate, stearyl(meth)acrylate, dicyclopentenyloxymethyl(meth)acrylate, benzyl(meth)acrylate, 2-phenoxyethyl(meth)acrylate, 3,3,5-trimethyl-cyclohexyl(meth)acrylate, 3-methylphenyl(meth)acrylate, 1-naphtyl(meth)acrylate, 3-phenyl-n-propyl(meth)acrylate and 2 phenyl-aminoethyl(meth)acrylate. Suitable substituted (meth)acrylamide functional monomers include e.g. alkyl(meth)acrylamide monomers such as t-octyl(meth)acrylamide and n-decyl(meth)acrylamide. Further examples of suitable monomers for introducing the first monomeric units to the random copolymer include vinyl monomers such as vinyl toluene, vinyl alkyl halide, styrene, vinyl pyridine, alpha methyl styrene dimer, vinyl esters of versatic acid such as VEOVA® 9 or VEOVA® 10, vinyl halide, and vinylidene chloride, and mixtures thereof. The first monomeric units in the copolymer can be derived from one or more than one monomer selected from alkyl(meth)acrylates, cycloalkyl(meth)acrylates, alkylcyclo(meth)acrylates, aralkyl(meth)acrylates, alkylaryl(meth)acrylates and aryl(meth)acrylates.

The second monomeric units of the random copolymer are derived from ethylenically unsaturated monomers and comprise other functional groups (different from the adhesion promoting functional groups on first monomeric units) that promote adhesion to a substrate. Choices of the second monomeric units also include examples of the first monomeric unit. Suitable monomers that introduce the other adhesion promoting functional groups include aromatic, bulky aromatic, amino, sulfide, mercapto, uredo, organometal, or organometalloids functionalized (meth)acrylates. Examples of organometal and organometalloids functional moieties include alkoxy silanes, alkoxy tinanates, alkoxy zirconates or the like. Alternatively or in addition, the second monomeric units may be diffusible into a substrate and/or a coated substrate and/or a subsequent coating layer when applied thereto with resulting crosslinking of the copolymer within the substrate and/or the coated substrate and/or the subsequent coating layer.

The random copolymer of the present invention may optionally include further monomeric units, which are different from the first and second monomeric units. Such further monomeric units may comprise one or more than one active hydrogen-containing functional group. The term “active hydrogen group-containing functional group” means a functional group that contains one or more than one hydrogen atom, which is able to participate under dissociation of the original bond to the hydrogen atom in a chemical reaction. The further monomeric units may be included in the copolymer to provide for reactivity with groups present in the first or second component of reactive mixture (b)(ii) such as isocyanate groups or epoxy groups and/or to provide desired properties such as enhanced adhesion to a polymeric substrate to the resinous adhesion promoter and/or coating compositions produced therefrom. For example the one or more than one active hydrogen group-containing functional group can be selected from hydroxyl, amino, carboxy or thiol. Alternatively or in addition, further monomeric units can be derived from respective ethylenically unsaturated monomers such as ethylenically unsaturated acids. Thus, the further monomeric units can be derived from one or more than one ethylenically unsaturated monomer having one or more than one active hydrogen group-containing functional group such as hydroxyl, amino, carboxy and/or thiol group and/or ethylenically unsaturated moieties. For example, the second monomeric units may be derived from hydroxyl functional ethylenically unsaturated monomers and/or ethylenically unsaturated acids

Such further monomeric units thus include those derived from ethylenically unsaturated monomers with relatively short organic substituents having less than six carbon atoms, which do not contain active-hydrogen-containing functional groups or halogen substituents. Non-limiting examples of monomers, which can be used in the preparation of the random copolymer to introduce such further monomeric units include alkyl(meth)acrylates, wherein the alkyl group has one to five carbon atoms, such as methyl(meth)acrylate, butyl acrylate an (meth)acrylic acid.

Suitable hydroxyl functional monomers that are reactive with functional groups of the first or second component include for example hydroxyl functional (meth)acrylic acid alkyl esters such as 2-hydroxyethyl(meth)acrylate, 2-hydroxypropyl(meth)acrylate, 3-hydroxypropyl(meth)acrylate, 4-hydroxybutyl(meth)acrylate, or an adduct of (meth)acrylic acid/glycidyl neodecanoate. In addition, other suitable hydroxyl containing monomers that may be used include ethylene glycol allyl ether, propylene glycol allyl ether, butylene glycol allyl ether, diethylene glycol allyl ether, cyclomethylol propene allyl ether and hydroxymethylnorbornene, allyl alcohol, methyl allyl alcohol, and unsaturated fatty alcohols. Non-limiting ethylenically unsaturated acids that can be used as monomers for introducing second monomeric units to the random copolymer according to the present invention include e.g. (alkyl)acrylic acids such as acrylic acid or methacrylic acid, or maleic acid. The further monomeric units may in particular be derived from hydroxyl functional (meth)acrylic acid alkyl esters and/or methacrylic acid. Other monomers from which the further monomeric units in the random copolymer may be derived include amine functional monomers. Suitable amine functional monomers include e.g. polyamines having at least two functional groups such as di-, tri-, or higher functional polyamines, which may be aromatic and/or aliphatic.

The first monomeric units of the random copolymer having a halogen substituent or a pendant organic group with six or more carbon atoms may be present in the random copolymer in an amount of at least 20 wt. % such as at least 30 wt. % or at least 50 wt. % or at least 75 wt. % and may be present in an amount of up to 95 wt. %, such as up to 90 wt. % or up to 85 wt. % or to up to 80 wt. %, based on the total solids weight of the random copolymer. The second monomeric units of the random copolymer may be present in the random copolymer in an amount of at least 5 wt. % such as at least 10 wt. % or at least 15 wt. % or at least 20 wt. % or at least 30 wt. % or at least 40 wt. % and may be present in an amount of up to 50 wt. % or up to 40 wt. % or up to 30 wt. % or up to 20 wt. % or up to 15 wt. %. The optional further monomeric units of the random copolymer may be present in the random copolymer in an amount of at least 5 wt. % such as at least 10 wt. % or at least 15 wt. % or at least 20 wt. % and may be present in an amount of up to 25 wt. % or up to 20 wt. % or up to 15 wt. %. It should be understood that the sum of the amounts of the first, second, and optional further monomeric units always totals 100%. It should be understood that the sum of the amounts of the first, second, and optional further monomeric units always totals 100%.

The random copolymer may be produced by copolymerizing monomers from which the first, second and optionally further monomeric units can be derived, respectively, e.g. using conventional radical polymerization or any living polymerization techniques, including but not limited to cationic polymerization, anionic polymerization, cobalt mediated polymerization, iodine mediated polymerization, group transfer polymerization, reverse addition-fragmentation chain transfer (RAFT) polymerization, atom transfer radical polymerization (ATRP) or nitroxide mediated polymerization (NMP) techniques. It is to be understood that the monomers of the random copolymer may be added in any order (sequence) or all at once and that the relative amounts of the first, second, and optional further monomeric units can be adjusted by controlling the amounts of the different monomers.

A coating composition according to the present invention can comprise the above-described random copolymer of the present invention as a reactive or non-reactive adhesion promoting component of the coating composition and further contain another non-reactive adhesion promoter. Typically, the other non-reactive adhesion promoting component is a polyolefin or chemically modified polyolefin such as a halogenated polyolefin. The polyolefins or modified polyolefins can, for example, be homopolymers produced from ethylene, propylene or higher alkylenes or copolymers from two or more such monomers. Suitable components for non-reactive adhesion promoter include chlorinated polyolefins (CPOs), such as those available commercially from Nippon Paper Chemicals under the trade designations SUPERCHLON JF2211S, 930S, 822S, E-723, E-673, and/or E-503. Alternative components for other non-reactive adhesion promoter include non-chlorinated polyolefins, such as those commercially available from Eastman under the trade name ADVANTIS 510W and/or those available commercially from Nippon Paper Chemicals under the trade names AUROREN AE 201 and/or AE-301.

As used herein, a “non-reactive component” is a component of a composition that does not chemically react with other components of the composition. Likewise, “a non-reactive adhesion promoter” is a component of a composition that does not chemically react with other components of the composition and which promotes adhesion of the composition or a coating layer formed therefrom to a substrate, e.g. a polyolefin-based substrate, such as the random copolymer adhesion promoting additive described herein. As such, the present invention also includes a coating composition comprising a film-forming polymer, the random copolymer of the present invention, and another adhesion promoter (e.g. CPO), wherein the random copolymer may or may not react with the film-forming polymer and/or the other adhesion promoter. The random copolymer adhesion promoter composition has monomeric units comprising halogen and/or a pendant organic group having six or more carbon atoms such as those described above that promote adhesion to a substrate.

The random copolymer and the other adhesion promoter (e.g., CPO), if used, may be provided as separate additions to a coating composition or together as a pre-mixture or as a composite material. By “composite material”, it is meant to include a structure wherein the random copolymer of the present invention at least partially encapsulates the adhesion promoter additive. As used herein, the term “encapsulated” refers to a feature of particles of the other adhesion promoter that are at least partially enclosed by (i.e. covered by) the random copolymer to an extent sufficient to physically separate particles of the other adhesion promoter from each other within a dispersion, which may be aqueous or solvent based, thereby preventing agglomeration of the other adhesion promoter. It will be appreciated that dispersions of the composite material of the present invention may also include an adhesion promoter that is not encapsulated within the random copolymer. Encapsulation, or at least partial encapsulation, of the other adhesion promoter in the random copolymer of the present invention may be accomplished by adding the other adhesion promoter into a random copolymer solution with solvent(s) in which the other adhesion promoter may not be dissolved in at room temperature.

By “film-forming polymer” it is meant a polymer that can form a self-supporting continuous film on at least a horizontal surface of a substrate upon removal of any diluents or carriers in the composition or upon curing at ambient or elevated temperatures.

The film-forming polymer may comprise a thermoplastic polymer and/or thermosetting polymer. The one or more than one film-forming polymer may be waterborne or solvent-based.

As used herein, the term “thermosetting” refers to polymeric materials that “set” irreversibly upon curing or crosslinking, wherein the polymer chains of the constituent polymer molecules are joined together by covalent bonds. This property is usually associated with a crosslinking reaction of the polymer often induced, for example, by heat or radiation. Curing or crosslinking reactions also may be carried out under ambient conditions. Once cured or crosslinked, a thermosetting resin will not melt upon the application of heat and is insoluble in solvents. Suitable thermosetting film-forming polymers include, for example, acrylic polymers, polyvinyl polymers, phenolics, polyester polymers, polyurethane polymers, polyamide polymers, polyether polymers, polysiloxane polymers, copolymers thereof, and mixtures thereof.

As used herein, the term “thermoplastic” refers to polymeric materials, wherein the constituent polymer molecules are joined by non-covalent intermolecular forces and thereby can undergo a reversible transition from solid to liquid or flowable state upon heating and be soluble in solvents. Suitable thermoplastic film-forming polymers include, but are not limited to, thermoplastic acrylic polymers, thermoplastic polyolefins, such as polyethylene or polypropylene, thermoplastic polyamides, such as nylon, thermoplastic polyurethanes, thermoplastic polyesters, thermoplastic vinyl polymers, polycarbonates, acrylonitrile-butadiene-styrene (“ABS”) copolymers, ethylene propylene diene terpolymer (“EPDM”) rubber, copolymers, and mixtures of any of the foregoing. Generally these polymers can be any polymers of these types made by any method known to those skilled in the art. Such polymers may be solvent borne or water dispersible, emulsifiable, or of limited water solubility.

The film-forming polymer may be any film-forming polymer as used in conventional primer compositions and/or a basecoat compositions. By “primer composition” (also referred to as a “sealer”) it is meant a coating composition designed to adhere to substrates and form a binding layer between the substrate and an overlying coating, such as a layer formed from a basecoat composition. By “basecoat composition” it is meant a coating composition that typically is applied over a coating formed from a primer composition and may include components (such as pigments and/or flake material) that impact the color and/or visual effects of the basecoat composition and coating formed therefrom.

The concentration of random copolymer included as a non-reactive component in the coating compositions according to the present invention may be up to 40 wt. % or up to 30 wt. % or up to 20 wt. %, based on total solids weight of the coating composition. The random copolymer may be used as component in a concentration of at least 1 wt. % or at least 2 wt. % or at least 3 wt. % or at least 4 wt. % or at least 5 wt. % or at least 10 wt. % or at least 20 wt. %, based on total solids weight of the coating composition. The random copolymer as described herein above may be used as an adhesion promoting component in a concentration of 1 to 50 wt. % or 5 to 30 wt. % based on the total solids weight of the coating composition.

The concentration of the other adhesion promoter (e.g. polyolefin or chemically modified polyolefin such as CPO) in a coating composition of the present invention may be up to 15 wt. % or up to 12 wt. % or up to 10 wt. % or up to 5 wt. % or up to 1 wt. % based on the total solids weight of the coating composition. The other adhesion promoter may be present in a concentration of at least 0.5 wt. % or at least 1 wt. % or at least 5 wt. %, based on the total solids weight of the coating composition. The other adhesion promoter as described herein above may for example be used in a concentration of 0.5 to 15 wt. % or 1 to 5 wt. % based on the total solids weight of the coating composition.

The coating composition of the present invention including the random copolymer as an adhesion promoting component exhibits enhanced adhesion to various substrates, including polymeric substrates, metallic substrates, ceramic substrates, wood substrates, as well as these or other substrates that are coated with an alkyd resin or aged alkyd resin, compared to a coating composition not including the random copolymer adhesion promoter component. By “aged” it is meant oxidizing the alkyd resin, in which, the alkyd resin was crosslinked over a period of time and became more difficult to overcoat. The coating composition including the random copolymer as a non-reactive adhesion promoter component is suitable for use as a primer composition applied directly to a substrate (which may or may not be pre-cleaned) and promoting adhesion thereto.

A substrate may be treated by first cleaning at least a portion of the polymeric substrate as described below. The resinous adhesion promoter composition comprising the random copolymer and another adhesion promoter, such as a polyolefin (e.g. CPO) may be applied directly to a cleaned polymeric substrate or an untreated polymeric substrate. By “untreated”, it is meant that the substrate has not been pre-sanded and/or pre-cleaned with a detergent, solvent, or CPO or the like. In this manner, the conventional steps of multiple CPO wipes may be avoided.

The random copolymer of the present invention is also suitable as a reactant of a resinous binder for use as a primer composition applied directly to a polymeric substrate and promoting adhesion thereto. A resinous adhesion promoter composition including the random copolymer and reactive mixture with or without a non-reactive adhesion promoter (such as a polyolefin, e.g. CPO) can be deposited onto a polymeric substrate by any conventional method including brushing, dipping, flow coating, spraying and allowed to cure at ambient conditions or at elevated temperature, as needed for curing the coating composition.

The first component and second component of reaction mixture may be components of a coating composition that is produced from two components that react when contacted with each other either in ambient conditions or at elevated temperature, such as a polyol and an isocyanate of a polyurethane coating composition. At least one of the first and second components of the reactive mixture comprises functional groups, which are reactive with the active-hydrogen-containing groups of the further monomeric units of the random copolymer, which can be any active-hydrogen-containing groups as described above, under ambient conditions or at elevated temperature. The functional groups reactive with the active-hydrogen-containing groups of the random copolymer can for example be selected from epoxy, anhydride, isocyanate groups or mixtures and combinations thereof. It should be appreciated that the present invention is not limited to a specific two-component coating chemistry. For example, the first component may include hydroxyl functional moieties and the second component may include isocyanate functional moieties. Other reactive functionalities are also within the scope of the invention; for example, the first component may include a polyamine or a polyacid, and the second component may include a species reactive with the functionality on the first component, such as an epoxy, melamine, anhydride, alkoxysilane, and the like. When the first component includes acid functional moieties, the second component may include carbodiimide functionality. Likewise, both the first and second components may each have silane functionalities or thiol functionalities.

The concentration of random copolymer included as a reactant of a resinous binder for use as a primer composition may be up to 40 wt. % or up to 30 wt. % or up to 20 wt. %. The random copolymer may be used as a reactant in a concentration of at least 1 wt. % or at least 2 wt. % or at least 3 wt. % or at least 4 wt. % or at least 5 wt. % or at least 10 wt. % or at least 20 wt. %. The random copolymer as described herein above may be used as a reactant in a concentration of 1 to 40 wt. % or 5 to 30 wt. % based on the total solids in the coating composition.

The present invention is further directed to treating various substrates comprising applying to at least a portion of the substrate a coating composition as described above. Particularly suitable substrates include polymeric substrates, glass substrates, metallic substrates, and substrates covered with an alkyd resin coating which may be aged. The polymeric substrates for use with the coating compositions of the present invention include plastic substrates. As used herein, the term “plastic” includes any thermoplastic or thermosetting polymeric material used in injection or reaction molding, sheet molding, or other forming process whereby parts can be formed. The term “polymeric substrate” as used herein means a substrate that is made of one or more than one polymeric material, which may optionally comprise additives such as fillers. Suitable polymeric materials for the polymeric substrate include, for example, acrylonitrile butadiene styrene (“ABS”), polyolefins, polycarbonate, thermoplastic elastomer, polyester, thermoset polyurethane, thermoplastic polyurethane, and fiberglass reinforced polyester, among others. Common examples of polyolefins are polypropylene (PP), polyethylene, and polybutylene and include the class of thermoplastic polyolefin (“TPO”). TPO generally refers to polymer/filler blends usually including some fraction of PP (polypropylene), PE (polyethylene), BCPP (block copolymer polypropylene), rubber, and a reinforcing filler. Common fillers include, though not restricted thereto, talc, fiberglass, carbon fiber, wollastonite, and MOS (metal oxy sulfate). Common rubbers include EPR (ethylene propylene rubber), EPDM (EP-diene rubber), EO (ethylene-octene), EB (ethylene butane rubber), and SEBS (styrene-ethylene-butadiene-styrene). The present invention is particularly useful for polyolefin-based substrates such as polyolefin substrates and thermoplastic polyolefin substrates. The presented invention also is applicable onto substrates that are capable to form bonding with silane functional moieties on the adhesion resin, including glass, metal, metal oxide, and metal alloys substrates.

A substrate covered with an alkyd resin may be polymeric, metallic, ceramic, or wooden. By “alkyd resin” it is meant a coating composition having a polyester modified by the addition of fatty acids and which may be referred to as “oil-based coatings” in the paint industry. As such alkyd resin coated substrates age, the alkyd resin coating becomes increasingly more difficult to adhere additional coatings thereto.

The substrate may be pre-cleaned prior to deposition of the coating composition. The cleaning step refers to the removal of unwanted foreign matter from the surface, such as soil, dirt, cutting oils, waxes, finger oils, and sanding dust, among other things. The substrate may be cleaned by, for example, mechanically separating the unwanted matter from the substrate contacting the substrate with a cleaning composition, or a combination thereof. The cleaning composition can comprise a solvent, which is capable of dissolving the unwanted foreign matter, such as for example water and/or one or more organic solvent such as a hydrocarbon mixture, mineral spirits or the like. The cleaning composition can comprise one or more than one detergent. As used herein, the term “detergent” refers to a substance that reduces the surface tension of water, i.e., a surface-active agent or a surfactant, which concentrates at oil-water interfaces, exerts emulsifying action, and aids in removing contaminants from a surface. Detergents that might be used in the practice of the present invention include anionic, nonionic, amphoteric and cationic surfactants used in conventional cleaning compositions. For example, the detergent may include d-limonene, an oil extracted from citrus rind. The detergent may be provided in a cleaning composition, in which the detergent may, for example, comprise 0.01 to 10.0 percent by weight, or 0.1 to 0.5 percent by weight, or 0.1 to 0.3 percent by weight of the cleaning composition based on the total weight thereof. The amount of detergent present in the cleaning composition can range between any combination of the recited values, inclusive of the recited values. Cleaning compositions that are particularly useful in the practice of the present invention can include a fatty acid ester, such as a soy-based fatty acid ester. Pre-cleaning with such cleaning compositions has been found to improve the adhesion of coatings such as coatings formed from the coating compositions according to the present invention to polymeric substrates.

Cleaning of the substrate may include contacting the substrate with an object, such as a pad or sponge, having a cleaning composition as described above in contact with or absorbed therein. The step of cleaning the substrate may include contacting the substrate with an abrasive material having the cleaning composition contained therein. Abrasive materials suitable for use in the methods and systems of the present invention are commercially available and include, for example, SCOTCH-BRITE™ Scuff Sponges, commercially available from 3M Company, St. Paul, Minn., and BEAR-TEX® Scuff Pads and Sponges, commercially available from Norton Abrasives.

In contrast to conventional practice, the coating compositions of the present invention having the random copolymer may be applied directly to the cleaned substrate, with no other pre-treatment of the substrate, other than the afore-described optional cleaning thereof. In this manner, conventional pre-treatment steps of sanding the substrate and/or wiping the substrate one or more times with a solvent and/or treatment of the substrate with a composition containing CPO can be avoided. According to the present invention, a substrate may be treated by cleaning at least a portion of the substrate and applying the composition of the present invention having the random copolymer directly on to the cleaned portion of the substrate.

The coating compositions of the present invention may be used as a primer composition and/or a basecoat composition in a multi-layered coating system. As such, further coating compositions may be applied to, e.g. over, the coating composition of the present invention or a coating layer formed therefrom. Examples of such further coating compositions include protective and/or decorative coating systems, such as basecoat compositions and/or clearcoat compositions and/or colored coating compositions, as described below.

The present compositions can be applied to any substrates known in the art, for example, automotive substrates, marine substrates, industrial substrates, heavy duty equipment, packaging substrates, lumber, wood flooring and furniture, apparel, electronics including housings and circuit boards and including consumer electronics such as housings for computers, notebooks, smartphones, tablets, televisions, gaming equipment, computer equipment, computer accessories, MP3 players, and the like, glass and transparencies, sports equipment including golf balls, and the like. These substrates can be, for example, metallic or non-metallic. Metallic substrates include tin, steel, tin-plated steel, chromium passivated steel, galvanized steel, aluminum, and aluminum foil. Metal sheet as used herein refers to flat metal sheet and coiled metal sheet, which is coiled, uncoiled for coating and then re-coiled for shipment to a manufacturer. Non-metallic substrates include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (“PET”), polycarbonate, polycarbonate acrylobutadiene styrene (“PC/ABS”), polyamide, wood, veneer, wood composite, particle board, medium density fiberboard, cement, stone, glass, paper, cardboard, textiles, leather both synthetic and natural, and the like. The substrate can be one that has been already treated in some manner, such as to impart visual and/or color effect. Suitable substrates can include those in which powder coatings are typically applied.

Protective and/or decorative coating systems that may be used in the present invention include, for example, those protective and/or decorative coating systems that are conventionally used in automotive refinish coating applications and automotive OEM applications, among others. Examples of suitable protective and/or decorative coating systems include single-layer coating systems, such as pigmented direct gloss coating systems, and multi-layered systems, such as systems that include a pigmented basecoat layer and a clear top coating layer. One or more layers of the protective and/or decorative coating system may be deposited from a coating composition that includes a polymeric composition that includes, without limitation, hydroxyl or carboxylic acid-containing acrylic copolymers, hydroxyl or carboxylic acid-containing polyester polymers and oligomers, isocyanate or hydroxyl-containing polyurethane polymers, and/or amine or isocyanate-containing polyureas. The one or more layers of the protective and/or decorative coating system may be deposited from a coating composition that includes one or more other additive ingredients, including those which are well known in the art of formulating surface coatings, such as dyes, pigments, surfactants, flow control agents, thixotropic agents, fillers, anti-gassing agents, organic co-solvents, catalysts, and other customary auxiliaries.

The coating compositions of the present invention may be used in refinishing of plastic articles. As used herein, the term “refinishing” refers to the act of restoring or repairing the surface or finish of an article or, in the case of automobile repairs, for example, the preparation of the surface or finish of an uncoated replacement article in connection with such a repair.

Illustrating the invention are the following examples that are not to be considered as limiting the invention to their details. All parts and percentages in the examples, as well as throughout the specification, are by weight unless otherwise indicated.

### EXAMPLES

The coatings produced in the Examples herein were tested on the substrates described below for adhesion in the cross hatch adhesion tests described below.

Galvanized Steel Substrates: The galvanized steel substrates, produced by Q-Lab Corporation (Westlake, Ohio), were wipe-cleaned with acetone using a piece of paper towel (such as WYPALL by Kimberly-Clark).

Aged Alkyd Coated Substrates (#1): Gloss alkyd resin DEVOE DEVGUARD 4308-6650 MEDIUM GREEN, commercially available from PPG Industries, Inc. (Pittsburgh, Pa.), was applied onto scrub panels, #P122-10N commercially available from Leneta Company, Inc., with a 3 mil bird bar and allowed to dry at room temperature for 3 days, followed by heat-curing at 48.9 C (120° F.) for 5 days to artificially “age” the alkyd layer. After drying, the panels were wipe-cleaned with a dry paper towel (such as WYPALL® by Kimberly-Clark).

Aged Alkyd Coated Substrates (#2): Pine wood panels, commercially available from SHR (Wageningen, The Netherlands), were coated with two layers of an alkyd resin (Schakelverf BWL, commercially available from PPG Industries, Inc.) with an interval of 24 hours and dried under atmosphere. The coated panels were then heated for 16 hours in an 80° C. oven to artificially “age” the alkyd layer. The panel was cooled under atmosphere for 4 hours before use.

Plastic Substrates: Plastic substrates of polypropylene (PP) and thermoplastic olefin (TPO) were used in the evaluation. The polypropylene substrates were Lyondell Basell Profax SB891 NAT, available from Standard Plaque Inc., Melvindale, Mich. The TPO substrates were from Lyondell Basell Hifax TRC 779X, available from Standard Plaque Inc. Unless otherwise noted, the plastic substrates were wipe-cleaned with an aliphatic hydrocarbon solvent mixture, flashed for 5 seconds, and wipe-dried with a piece of cheese cloth, prior to the application of the coating layer. The aliphatic hydrocarbon mixture included, but was not limited to VM&P Nathptha (available from W. M. Barr, Memphis, Tenn.), mineral spirits or the like, with a small percentage of isopropanol and Larostat 264A, available from BASP (Florhan Park, N.J.) optionally present.

Cross-hatch Adhesion Test on Galvanized Steel Substrates and Aged Alkyd Coated Substrates(#1): The cross-hatch adhesion test was performed using a PA-2054 GARDCO™ 1.5 mm blade (available from M.E. Taylor Engineering, Inc. Derwood, Md.), cut horizontally and vertically into the film to create a grid of 100 squares. The film was then lightly brushed to ensure the area to be tested was free of detached flakes or ribbons of coatings from the cross-hatching process.

To measure the dry adhesion, a 3 inch piece of tape (SEMICRO™ CHT tape, available from M.E. Taylor Engineering, Inc. Derwood, Md.) was placed over the cross-hatched area and smoothed firmly with a tongue depressor. The tape was then removed within 90±30 seconds of application by grabbing the free end in a swift, single motion as close to an angle of 180° as possible. The wet adhesion was measured similarly as measuring the dry adhesion, except that a water saturated paper towel (such as WYPALL®, available from Kimberly-Clark Corporation, Neenah, Wis.) was placed on top of the testing area for 30 minutes, then removed and allowed to air dry for 10 minutes before the same type of tape was placed over the cross-hatched area and removed in the same manner as described above.

Cross-hatch Adhesion Test on Aged Alkyd Coated Substrates (#2): The cross-hatch adhesion test on Aged Alkyd Coated Substrates #2 was performed using a BYK-MALLINCKRODT cross-cut tester (available from BYK USA, Wallingord, Conn.) with stainless steel shims, spaced 1 mm, was used to cut through the coating to the substrate. Six horizontal cuts and six vertical cuts were made perpendicular to each other to obtain a right angle lattice pattern. An adhesive tape (SCOTCH® 3M 8981 transparent tape, available from 3M Company, Minneapolis, Minn.) was firmly and uniformly applied over the crosshatched area and then firmly pulled away at an angle of 150 degrees to the substrate surface. The crosshatch was examined to assess how much coating had been pulled away, and a rating awarded as follows:

GT-5: crosshatched coating is completely free from damage.

GT-4: less than 5% of the coating pulled away.

GT-3: 5-15% of the coating pulled away.

GT-2: 15-35% of the coating pulled away.

GT-1: 35-65% of the coating pulled away.

GT-0: more detachment than GT-1.

To test the wet cross cut adhesion, two incisions were made in the film, 40 mm long that intersect near their middles with a smaller angle between 30 and 45 degrees. A water saturated cotton ball was placed for 1 hour over the incisions. After removal of the cotton ball, the excess of water was absorbed by a tissue. The adhesive tape was firmly and uniformly applied over the incision and then firmly pulled away at an angle of 150 degrees to the substrate surface. The cross-cut area was examined on detachment of the coating, and a rating awarded as follows:

GC-5: no detachment.

GC-4: traces of detachments along the cuts.

GC-3: detachment of 1.6 mm on both sides of the cuts.

GC-2: detachment of 3.2 mm on both sides of the cuts.

GC-1: detachment of most of the surface in between the crossing.

GT-0 detachment surface and surrounding of the crossing.

Cross-hatch Adhesion Test on Plastic Substrates: The cross-hatch adhesion test was performed using a template to cut at least 11 parallel lines spaced apart 2 mm both horizontally and vertically to create a grid of 100 squares that was placed upon the applied cured coating composition. First, with a retractable knife perpendicular to the panel surface, 11 parallel lines were cut through to the substrate surface using a 2 mm spacing template (cutting guide available from Taizu Kazai Co., Japan). The template was repositioned to make additional cuts at 90 degrees to the first set and cut as described above to create a grid of 100 squares. The film was lightly brushed with a soft brush or tissue to remove any detached flakes or ribbons of coatings. A 75 mm (3 inch) long piece of tape (SCOTCH® Filament Tape 898 available from 3M Company, Minneapolis, Minn.) was placed over the scribed lines in the same direction as one set of the lines. The taped was smoothed firmly over the substrate with an eraser or the backside of the blade-holder handle. The tape was then pulled off in one rapid, continuous motion while keeping the tape as close as possible to a 45 degree angle to the surface.

The adhesion results of the cross-hatch tests were converted into 6 ranking grades, i.e. 0=Fail, 1=Severe, 2=Poor, 3=Acceptable, 4=Good, 5=Excellent.

### Examples 1-21: Synthesis of Adhesion Promoting Copolymers

Copolymers were prepared using the materials listed in Table 1A, 1B, and 1C. For each of Examples 1-21, Charge 1 was added into a four-necked glass flask equipped with a condenser, a temperature measuring probe, mechanical stirring devices, and monomer/initiator feeding inlets. The setup was protected with nitrogen gas during the entire reaction. The mixture was heated to reflux at the listed Reaction Set Points, and at reflux, Charge 2 and Charge 3 were co-fed over 4 hours. After the feeds were completed, the reaction mixture was held for one additional hour. At the end of the hold, Charge 4 was added over 30 minutes. Finally, the reaction was ended by adding Charge 5 into the mixture. The final solids (weight percent nonvolatile, or % NV) were experimentally measured along with the number averaged molecular weight (Mₙ) and the polydispersity index (Ð) respectively (measured by gel permeation chromatography using polystyrene standards).

Table 2 shows the final resin compositions by weight percent (%) of the constitutional monomeric units derived from the different monomers, Mₙ, and Ð for the copolymers of Examples 1-4.

TABLE 1A

| | | | | | | | |
|---|---|---|---|---|---|---|---|
| Example | 1 | 2 | 3 | 4 | 5 | 6 | 7 |
| Reaction Set Point (Celsius) | 100 | 100 | 100 | 100 | 100 | 100 | 100 |

Components (parts by wt.)
Charge 1

| | | | | | | | |
|---|---|---|---|---|---|---|---|
| DOWANOL PM¹ | 0.0 | 0.0 | 0.0 | 0.0 | 0.0 | 0.0 | 0.0 |
| OXSOL ® 100² | 0.0 | 0.0 | 0.0 | 0.0 | 0.0 | 0.0 | 0.0 |
| t-butyl acetate | 1475.0 | 1475.0 | 1475.0 | 1475.0 | 1475.0 | 1475.0 | 1475.0 |

Charge 2

| | | | | | | | |
|---|---|---|---|---|---|---|---|
| LUPEROX 26³ | 9.1 | 9.1 | 9.1 | 9.1 | 9.1 | 9.1 | 9.1 |
| LUPEROX 270⁴ | 0.0 | 0.0 | 0.0 | 0.0 | 0.0 | 0.0 | 0.0 |
| OXSOL ® 100 | 0.0 | 0.0 | 0.0 | 0.0 | 0.0 | 0.0 | 0.0 |
| t-butyl acetate | 77.4 | 77.4 | 77.4 | 77.4 | 77.4 | 77.4 | 77.4 |

Charge 3

| | | | | | | | |
|---|---|---|---|---|---|---|---|
| Silane A174⁵ | 48.5 | 48.5 | 194.2 | 194.0 | 194.0 | 194.0 | 194.1 |
| Isobornyl acrylate (IBoA) | 921.7 | 485.1 | 542.9 | 543.3 | 543.3 | 543.3 | 543.3 |
| Butyl acrylate (BA) | 0.0 | 0.0 | 0.0 | 232.8 | 0.0 | 135.8 | 0.0 |
| 2-hydroxyethyl | 0.0 | 0.0 | 0.0 | 0.0 | 232.8 | 0.0 | 97.1 |
| acrylate (HEA) | | | | | | | |
| Methyl methacrylate | 0.0 | 436.6 | 232.8 | 0.0 | 0.0 | 97.0 | 135.8 |
| (MMA) | | | | | | | |

Charge 4

| | | | | | | | |
|---|---|---|---|---|---|---|---|
| LUPEROX 26 | 9.1 | 9.1 | 9.1 | 9.1 | 9.1 | 9.1 | 9.1 |
| LUPEROX 270 | 0.0 | 0.0 | 0.0 | 0.0 | 0.0 | 0.0 | 0.0 |
| OXSOL ® 100 | 0.0 | 0.0 | 0.0 | 0.0 | 0.0 | 0.0 | 0.0 |
| t-butyl acetate | 38.8 | 38.8 | 38.8 | 38.8 | 38.8 | 38.8 | 38.8 |

Charge 5

| | | | | | | | |
|---|---|---|---|---|---|---|---|
| OXSOL ® 100 | 0.0 | 0.0 | 0.0 | 0.0 | 0.0 | 0.0 | 0.0 |
| t-butyl acetate | 2362.4 | 2362.4 | 2362.4 | 2362.4 | 2362.4 | 2362.4 | 2362.4 |

Property

| | | | | | | | |
|---|---|---|---|---|---|---|---|
| % NV | 19.1% | 19.0% | 20.0% | 21.5% | 22.0% | 20.0% | 20.3% |

¹Solvent, propylene glycol monomethyl ether, available from Dow Chemical Co.
²Solvent, 4-chlorobenzotrifluoride, available from Jiangsu Dahua Chemical Industry
³Initiator, t-butylperoxy 2-ethylhexanoate, available from Arkema Inc.
⁴Initiator, tert-butyl peroxy-3,5,5-trimethylhexanoate, available from Arkema Inc.
⁵Silane acrylic monomers, 3-(trimethoxysilyl)propyl methacrylate, available from Sigma-Aldrich Co. LLC.

TABLE 1B

| | | | | | | | |
|---|---|---|---|---|---|---|---|
| Example | 8 | 9 | 10 | 11 | 12 | 13 | 14 |
| Reaction Set Point (Celsius) | 100 | 100 | 130 | 100 | 100 | 100 | 100 |

Components (parts by wt.)
Charge 1

| | | | | | | | |
|---|---|---|---|---|---|---|---|
| DOWANOL PM¹ | 0.0 | 0.0 | 0.0 | 0.0 | 0.0 | 0.0 | 0.0 |
| OXSOL ® 100² | 0.0 | 0.0 | 1475.0 | 0.0 | 0.0 | 0.0 | 0.0 |
| t-butyl acetate | 1475.0 | 1475.0 | 0.0 | 1475.0 | 1475.0 | 1475.0 | 1475.0 |

Charge 2

| | | | | | | | |
|---|---|---|---|---|---|---|---|
| LUPEROX 26³ | 9.1 | 9.1 | 0.0 | 9.1 | 9.1 | 9.1 | 9.1 |
| LUPEROX 270⁴ | 0.0 | 0.0 | 9.7 | 0.0 | 0.0 | 0.0 | 0.0 |
| OXSOL ® 100 | 0.0 | 0.0 | 77.4 | 0.0 | 0.0 | 0.0 | 0.0 |
| t-butyl acetate | 77.4 | 77.4 | 0.0 | 77.4 | 77.4 | 77.4 | 77.4 |

Charge 3

| | | | | | | | |
|---|---|---|---|---|---|---|---|
| Silane A174⁵ | 194.0 | 194.0 | 194.1 | 266.6 | 266.8 | 266.8 | 484.9 |
| Isobornyl acrylate (IBoA) | 543.3 | 543.3 | 543.3 | 703.2 | 48.5 | 376.0 | 484.9 |
| Butyl acrylate (BA) | 135.8 | 135.8 | 135.8 | 0.0 | 0.0 | 0.0 | 0.0 |
| 2-hydroxyethyl | 97.0 | 97.0 | 97.1 | 0.0 | 0.0 | 0.0 | 0.0 |
| acrylate (HEA) | | | | | | | |
| Methyl methacrylate | 0.0 | 0.0 | 0.0 | 0.0 | 654.9 | 327.4 | 0.0 |
| (MMA) | | | | | | | |

Charge 4

| | | | | | | | |
|---|---|---|---|---|---|---|---|
| LUPEROX 26 | 9.1 | 9.1 | 0.0 | 9.1 | 9.1 | 9.1 | 9.1 |
| LUPEROX 270 | 0.0 | 0.0 | 9.7 | 0.0 | 0.0 | 0.0 | 0.0 |
| OXSOL ® 100 | 0.0 | 0.0 | 38.8 | 0.0 | 0.0 | 0.0 | 0.0 |
| t-butyl acetate | 38.8 | 38.8 | 0.0 | 38.8 | 38.8 | 38.8 | 38.8 |

Charge 5

| | | | | | | | |
|---|---|---|---|---|---|---|---|
| OXSOL ® 100 | 0.0 | 0.0 | 388.1 | 0.0 | 0.0 | 0.0 | 0.0 |
| t-butyl acetate | 2362.4 | 194.1 | 0.0 | 2362.4 | 2362.4 | 2362.4 | 2362.4 |

Property

| | | | | | | | |
|---|---|---|---|---|---|---|---|
| % NV | 21.7% | 35.8% | 33.3% | 19.4% | 21.5% | 20.8% | 19.4% |

¹Solvent, propylene glycol monomethyl ether, available from Dow Chemical Co.
²Solvent, 4-chlorobenzotrifluoride, available from Jiangsu Dahua Chemical Industry
³Initiator, t-butylperoxy 2-ethylhexanoate, available from Arkema Inc.
⁴Initiator, tert-butyl peroxy-3,5,5-trimethylhexanoate, available from Arkema Inc.
⁵Silane acrylic monomers, 3-(trimethoxysilyl)propyl methacrylate, available from Sigma-Aldrich Co. LLC.

TABLE 1C

| | | | | | | | |
|---|---|---|---|---|---|---|---|
| Example | 15 | 16 | 17 | 18 | 19 | 20 | 21 |
| Reaction Set Point (Celsius) | 100 | 100 | 100 | 100 | 100 | 130 | 130 |

Components (parts by wt.)
Charge 1

| | | | | | | | |
|---|---|---|---|---|---|---|---|
| DOWANOL PM¹ | 0.0 | 0.0 | 0.0 | 0.0 | 0.0 | 104.8 | 104.8 |
| OXSOL ® 100² | 0.0 | 0.0 | 0.0 | 0.0 | 0.0 | 400.0 | 400.0 |
| t-butyl acetate | 1475.0 | 1475.0 | 1475.0 | 1475.0 | 1475.0 | 0.0 | 0.0 |

Charge 2

| | | | | | | | |
|---|---|---|---|---|---|---|---|
| LUPEROX 26³ | 9.1 | 9.1 | 9.1 | 9.1 | 9.1 | 0.0 | 0.0 |
| LUPEROX 270⁴ | 0.0 | 0.0 | 0.0 | 0.0 | 0.0 | 38.8 | 38.8 |
| OXSOL ® 100 | 0.0 | 0.0 | 0.0 | 0.0 | 0.0 | 77.4 | 77.4 |
| t-butyl acetate | 77.4 | 77.4 | 77.4 | 77.4 | 77.4 | 0.0 | 0.0 |

Charge 3

| | | | | | | | |
|---|---|---|---|---|---|---|---|
| Silane A174⁵ | 484.9 | 485.1 | 0.0 | 0.0 | 0.0 | 0.0 | 0.0 |
| Isobornyl acrylate (IBoA) | 266.6 | 48.5 | 97.0 | 252.1 | 349.1 | 0.0 | 756.7 |
| Butyl acrylate (BA) | 0.0 | 0.0 | 135.8 | 135.8 | 135.8 | 0.0 | 0.0 |
| 2-hydroxyethyl | 0.0 | 0.0 | 97.0 | 97.0 | 97.0 | 106.7 | 106.7 |
| acrylate (HEA) | | | | | | | |
| Methyl methacrylate | 218.3 | 436.6 | 640.1 | 484.9 | 387.9 | 863.4 | 106.7 |
| (MMA) | | | | | | | |

Charge 4

| | | | | | | | |
|---|---|---|---|---|---|---|---|
| LUPEROX 26 | 9.1 | 9.1 | 9.1 | 9.1 | 9.1 | 0.0 | 0.0 |
| LUPEROX 270 | 0.0 | 0.0 | 0.0 | 0.0 | 0.0 | 9.7 | 9.7 |
| OXSOL ® 100 | 0.0 | 0.0 | 0.0 | 0.0 | 0.0 | 38.8 | 38.8 |
| t-butyl acetate | 38.8 | 38.8 | 38.8 | 38.8 | 38.8 | 0.0 | 0.0 |

Charge 5

| | | | | | | | |
|---|---|---|---|---|---|---|---|
| OXSOL ® 100 | 0.0 | 0.0 | 0.0 | 0.0 | 0.0 | 388.1 | 388.1 |
| t-butyl acetate | 2362.4 | 2362.4 | 2362.4 | 2362.4 | 2362.4 | 0.0 | 0.0 |

Property

| | | | | | | | |
|---|---|---|---|---|---|---|---|
| % NV | 19.7% | 19.6% | 19.5% | 20.1% | 20.4% | 50.2% | 50.2% |

¹Solvent, propylene glycol monomethyl ether, available from Dow Chemical Co.
²Solvent, 4-chlorobenzotrifluoride, available from Jiangsu Dahua Chemical Industry
³Initiator, t-butylperoxy 2-ethylhexanoate, available from Arkema Inc.
⁴Initiator, tert-butyl peroxy-3,5,5-trimethylhexanoate, available from Arkema Inc.
⁵Silane acrylic monomers, 3-(trimethoxysilyl)propyl methacrylate, available from Sigma-Aldrich Co. LLC.

TABLE 2
Copolymers

| | | | | | | Mₙ | |
|---|---|---|---|---|---|---|---|
| Example | A174 | IBoA | BA | HEA | MMA | (g/mol) | Ð |
| 1 | 5.0% | 95.0% | 0.0% | 0.0% | 0.0% | 3300 | 2.3 |
| 2 | 5.0% | 50.0% | 0.0% | 0.0% | 45.0% | 8400 | 4.7 |
| 3 | 20.0% | 56.0% | 0.0% | 0.0% | 24.0% | 7200 | 7.5 |
| 4 | 20.0% | 56.0% | 24.0% | 0.0% | 0.0% | 5700 | 4.5 |
| 5 | 20.0% | 56.0% | 0.0% | 24.0% | 0.0% | 7900 | 7.3 |
| 6 | 20.0% | 56.0% | 14.0% | 0.0% | 10.0% | 5900 | 4.0 |
| 7 | 20.0% | 56.0% | 0.0% | 10.0% | 14.0% | 6100 | 4.5 |
| 8 | 20.0% | 56.0% | 14.0% | 10.0% | 0.0% | 6400 | 5.0 |
| 9 | 20.0% | 56.0% | 14.0% | 10.0% | 0.0% | 5500 | 4.7 |
| 10 | 20.0% | 56.0% | 14.0% | 10.0% | 0.0% | 3900 | 4.2 |
| 11 | 27.5% | 72.5% | 0.0% | 0.0% | 0.0% | 4200 | 3.1 |
| 12 | 27.5% | 5.0% | 0.0% | 0.0% | 67.5% | 11200 | 4.6 |
| 13 | 27.5% | 38.8% | 0.0% | 0.0% | 33.7% | 7400 | 7.1 |
| 14 | 50.0% | 50.0% | 0.0% | 0.0% | 0.0% | 5500 | 5.0 |
| 15 | 50.0% | 27.5% | 0.0% | 0.0% | 22.5% | 4300 | 3.2 |
| 16 | 50.0% | 5.0% | 0.0% | 0.0% | 45.0% | 6100 | 5.2 |
| 17 | 0.0% | 10.0% | 14.0% | 10.0% | 66.0% | 11100 | 3.8 |
| 18 | 0.0% | 26.0% | 14.0% | 10.0% | 50.0% | 9200 | 4.7 |
| 19 | 0.0% | 36.0% | 14.0% | 10.0% | 40.0% | 7500 | 5.2 |
| 20 | 0.0% | 0.0% | 0.0% | 11.0% | 89.0% | 5300 | 3.0 |
| 21 | 0.0% | 78.0% | 0.0% | 11.0% | 11.0% | 2800 | 2.3 |

### Examples 22-33: Adhesion Promoting Blends

The copolymers of Examples 6-10, 20, and 21 were blended with chlorinated polyolefin (CPO) using the materials listed in Table 3. Charge 1 was added into a 1 L four-necked glass flask equipped with a condenser, a temperature measuring probe, and mechanical stirring devices and heated to 90° C., whereupon Charge 2 was added into the flask. The mixture was held at 90° C. until the Charge 2 was completely dissolved. Charge 3 was then added into the flask, and the mixture was held at 90° C. for an additional 3 hours. After the hold, the mixture was cooled to 40° C., Charge 4 was added into the flask and the reaction was mixed for an additional 30 minutes.

TABLE 3
Adhesion Promoting Blends

| | | | | | | | | | | | | |
|---|---|---|---|---|---|---|---|---|---|---|---|---|
| Example | 22 | 23 | 24 | 25 | 26 | 27 | 28 | 29 | 30 | 31 | 32 | 33 |

Components (parts by wt.)
Charge 1

| | | | | | | | | | | | | |
|---|---|---|---|---|---|---|---|---|---|---|---|---|
| OXSOL ® 100 | 0 | 0 | 0 | 0 | 0 | 0 | 0 | 79.2 | 87.1 | 96 | 250.7 | 250.7 |
| t-butyl acetate | 14.5 | 16.1 | 22.6 | 0 | 0 | 0 | 89.6 | 0 | 0 | 0.0 | 0 | 0 |
| EXXSOL ™ D40⁶ | 0 | 0 | 0 | 28.6 | 60.0 | 208.2 | 0 | 0 | 0 | 0 | 0 | 0 |

Charge 2

| | | | | | | | | | | | | |
|---|---|---|---|---|---|---|---|---|---|---|---|---|
| SUPERCHLON ® | 3.5 | 3.6 | 3.8 | 6.1 | 40.0 | 34.4 | 34.4 | 1.8 | 3.8 | 6.1 | 49.3 | 49.3 |
| 930S⁷ | | | | | | | | | | | | |

Charge 3

| | | | | | | | | | | | | |
|---|---|---|---|---|---|---|---|---|---|---|---|---|
| Butanol | 0.13 | 0.14 | 0.14 | 0.27 | 0.00 | 1.31 | 1.31 | 0.07 | 0.15 | 0.23 | 1.86 | 1.86 |

Charge 4

| | | | | | | | | | | | | |
|---|---|---|---|---|---|---|---|---|---|---|---|---|
| Adhesion | Ex. 6 | Ex. 7 | Ex. 8 | Ex. 9 | NA | Ex. 9 | Ex. 9 | Ex. 10 | Ex. 10 | Ex. 10 | Ex. 20 | Ex. 21 |
| Promoting | | | | | | | | | | | | |
| Copolymer | | | | | | | | | | | | |
| | 100 | 100 | 100 | 100 | 0 | 100 | 100 | 100 | 100 | 100 | 100 | 100 |
| Weight ratio of | 85:15 | 85:15 | 85:15 | 85:15 | 0:100 | 50:50 | 50:50 | 95:5 | 10:90 | 15:85 | 50:50 | 50:50 |
| copolymer solids: | | | | | | | | | | | | |
| CPO | | | | | | | | | | | | |

Property

| | | | | | | | | | | | | |
|---|---|---|---|---|---|---|---|---|---|---|---|---|
| % NV | 20.0% | 20.1% | 20.3% | 30.2% | 40.0% | 20.4% | 31.0% | 20.0% | 20.1% | 20.1% | 25.0% | 25.0% |

⁶Solvent, mixture of normal paraffins, isoparaffins, and cycloparaffins, available from Exxon Mobil Chemical Corporation.
⁷Chlorinated polyolefin containing 5% maleic anhydride available from Nippon Paper Industries.

### Examples 34-60: Adhesion Testing on Galvanized Steel and Aged Alkyd Coated Substrates (#1)

Galvanized steel substrates and Aged Alkyd Coated Substrates (#1) were prepared as described above for use in Examples 34-58. The compositions of Examples 1-19, 22-24, and 29-31 were directly applied using a 1″ foam brush (product no. RVN00081/EA available from PPG Industries, Inc., Pittsburgh, Pa.) at approximately 4-6 wet mils to the two sets of substrates (galvanized steel and Aged Alkyd #1) and flashed overnight at room temperature, and wiped off the next day. A topcoat of MANOR HALL® Timeless 73-410XI exterior paint (available from PPG Industries, Inc.) was applied to the coated galvanized steel substrates, and a topcoat of VALSPAR Reserve Satin Pastel 535150 exterior paint (available from The Valspar Corporation, Minneapolis, Minn.) was applied onto the Aged Alkyd #1 substrates by drawdown using a 3 mil bird bar (product no. 5566, available from BYK-Gardner, Geretsried, Bavaria, Germany). Two control panels with topcoats (without any adhesion promoting material) were produced as Comparative Examples 59 and 60.

After one day of drying under ambient conditions, both wet and dry adhesion tests were performed on each panel as described, and the results are reported in Table 4. Compositions not blended with an adhesion promoting additive (CPO) reported in Examples 34-39, 41, 43, 45, 46, and 50-55 demonstrate that minimum amounts of silane monomer (A174) and IBoA in an adhesion promoting copolymer with various optional acrylic monomers and varying solvents enhances adhesion to both galvanized steel and Aged Alkyd #1. As such, universal adhesion performance was observed on galvanized steel and Aged Alkyd (#1) as compared to the controls (Comparative Examples 59 and 60) when at least 20% silane acrylic monomers (A174) or more than 50% IBoA is included as shown in Examples 34-41, 43, 45, 46, and 50-55. These results also suggested that other acrylic monomers can be used in place of MMA with similar adhesion performance as shown in Examples 36-38. Compositions blended with CPO are shown to improve adhesion to at least Aged Alkyd #1 in Examples 39-44 and 46-49. Compositions without silane monomer that were blended with CPO also exhibited adhesion promoting properties in Examples 56-58.

### Examples 61-67: Adhesion Testing on Aged Alkyd Coated Substrates (#2)

In Examples 61-65, Aged Alkyd Coated Substrates (#2) were prepared as described above. The coating compositions (˜60 μm) of Examples 9 and 25-28 were then directly, without sanding, applied to the substrates by brush, flashed overnight at room temperature. A topcoat (SIGMA SCHAKELVERF BZ tinted, commercially available in The Netherlands from PPG Industries, Inc.) was applied by brush onto the coated Aged Alkyd Coated Substrates (#2). Comparative Example 66 was prepared according to Example 62, except that the copolymer Example 9 in the Copolymer/CPO blend Example 25 was replaced with a long alkyd compatible acrylic copolymer WorléeCryl L 2822 (no IBoA or silane acrylic monomer), commercially available from Worlée-Chemie GmbH. In Comparative Example 67, a control panel with a topcoat but in the absence of any adhesion promoting copolymers or copolymer/CPO blend was also prepared. After one day of drying under ambient conditions, both wet and dry adhesion tests were performed on each panel as described, and result was reported in Table 4.

The results in Table 4 show that the IBoA/silane acrylic monomer-containing copolymer resin of the present invention improves the adhesion performance on Aged Alkyd Coated Substrates (#2), with or without CPO. The results also indicate that a 50:50 blend of copolymer resin and CPO at lower % non-volatiles or in the absence of solvent (e.g. EXXSOL D40) provides good adhesion performance, as shown in Examples 64 and 65, respectively.

### Examples 68-73: Adhesion Testing on PP and TPO Promoting Resin Examples 10, 20, and 21

Polymeric substrates were pre-cleaned using the pre-cleaning method described above. The % NV of the adhesion promoting copolymers without CPO (Examples 10, 20, and 21) and with CPO (Examples 32 and 33) were adjusted to the targeted % NV listed in Table 4 by weight using OXSOL 100 solvent, as needed. The diluted resin solutions were then directly applied to the pre-cleaned substrates of thermoplastic olefin (TPO) and polypropylene (PP) and flashed for 30 minutes at room temperature.

In Examples 68-72, a two-component isocyanate based primer composition was prepared by blending 367.5 parts of ECS25 primer (commercially available from PPG Industries, Inc.) with 77.3 parts of EH391 hardener (commercially available from PPG Industries, Inc.) and 82.6 parts OXSOL® 100 solvent. The formulated primer composition was applied directly on the top of the copolymer coated substrates by spraygun. The primer composition was cured at ambient temperature for 30 minutes. Subsequently, the coated substrates were further coated with a basecoat T409 ENVIROBASE BLACK and a clearcoat (DC4000 and DCH3085, respectively, and are commercially available from PPG Industries, Inc.) with a flash time of 30 minutes between coats at ambient temperature. The dry film thicknesses of the copolymer coating layer, the basecoat, and the clearcoat are approximately 1.43, 0.46, and 2.13 mils, respectively. In Comparative Example 73, substrates of TPO and PP were each coated with the primer composition, but without any adhesion promoting material.

After 7 days ambient cure, cross-hatch adhesion tests on the plastic substrates were performed as reported in Table 4. Example 68-72 and 73 showed that the IBoA/silane acrylic-containing copolymer resin improves adhesion performance on the polymeric substrates. In the absence of the silane acrylic monomer in the copolymer, incorporation of the IBoA and the addition of CPO improves the adhesion properties on the polymeric substrates, especially on polypropylene, which is known to be a substrate to which adhesion can be difficult.

TABLE 4

| | | | | | Wet and dry adhesion performance | | | | | | | |
|---|---|---|---|---|---|---|---|---|---|---|---|---|
| | | | | | 0 = Fail, 1 = Severe, 2 = Poor, 3 = Acceptable, | | | | | | | |
| | | | | | 4 = Good, 5 = Excellent | | | | | | | |
| | | Weight | Adjusted | | Galvanized | | | | | | | |
| | Adhesion | Ratio of | Final | | Steel | | Aged Alkyd #1 | | Aged Alkyd #2 | | PP | TPO |
| Example | Promoting | Copolymer | % NV of | | 1 Day | 1 Day | 1 Day | 1 Day | 1 Day | 1 Day | 7 Day | 7 Day |
| Tests | Copolymer | to CPO | Copolymer | Solvent | Wet | Dry | Wet | Dry | Wet | Dry | Dry | Dry |
| 34 | Ex. 1 | 100:0 | 20.5 +/− 1.5% | t-butyl | 0 | 0 | 0 | 0 | | | | |
| | | | | acetate | | | | | | | | |
| 35 | Ex. 2 | 100:0 | 20.5 +/− 1.5% | t-butyl | 0 | 0 | 0 | 2 | | | | |
| | | | | acetate | | | | | | | | |
| 36 | Ex. 3 | 100:0 | 20.5 +/− 1.5% | t-butyl | 2 | 2 | 2 | 4 | | | | |
| | | | | acetate | | | | | | | | |
| 37 | Ex. 4 | 100:0 | 20.5 +/− 1.5% | t-butyl | 5 | 5 | 3 | 1 | | | | |
| | | | | acetate | | | | | | | | |
| 38 | Ex. 5 | 100:0 | 20.5 +/− 1.5% | t-butyl | 5 | 5 | 3 | 4 | | | | |
| | | | | acetate | | | | | | | | |
| 39 | Ex. 6 | 100:0 | 20.5 +/− 1.5% | t-butyl | 4 | 2 | 4 | 1 | | | | |
| | | | | acetate | | | | | | | | |
| 40 | Ex. 22 | 85:15 | 20.5 +/− 1.5% | t-butyl | 5 | 4 | 5 | 4 | | | | |
| | | | | acetate | | | | | | | | |
| 41 | Ex. 7 | 100:0 | 20.5 +/− 1.5% | t-butyl | 5 | 4 | 2 | 4 | | | | |
| | | | | acetate | | | | | | | | |
| 42 | Ex. 23 | 85:15 | 20.5 +/− 1.5% | t-butyl | 4 | 4 | 4 | 4 | | | | |
| | | | | acetate | | | | | | | | |
| 43 | Ex. 8 | 100:0 | 20.5 +/− 1.5% | t-butyl | 5 | 5 | 4 | 4 | | | | |
| | | | | acetate | | | | | | | | |
| 44 | Ex. 24 | 85:15 | 20.5 +/− 1.5% | t-butyl | 4 | 4 | 4 | 4 | | | | |
| | | | | acetate | | | | | | | | |
| 45 | Ex. 9 | 100:0 | 20.5 +/− 1.5% | t-butyl | 5 | 5 | 4 | 4 | | | | |
| | | | | acetate | | | | | | | | |
| 46 | Ex. 10 | 100:0 | 20.5 +/− 1.5% | OXSOL ® | 4 | 5 | 2 | 1 | | | | |
| | | | | 100 | | | | | | | | |
| 47 | Ex. 29 | 95:5 | 20.5 +/− 1.5% | OXSOL ® | 5 | 3 | 4 | 3 | | | | |
| | | | | 100 | | | | | | | | |
| 48 | Ex. 30 | 90:10 | 20.5 +/− 1.5% | OXSOL ® | 5 | 4 | 4 | 4 | | | | |
| | | | | 100 | | | | | | | | |
| 49 | Ex. 31 | 85:15 | 20.5 +/− 1.5% | OXSOL ® | 5 | 4 | 4 | 4 | | | | |
| | | | | 100 | | | | | | | | |
| 50 | Ex. 11 | 100:0 | 20.5 +/− 1.5% | t-butyl | 5 | 5 | 5 | 5 | | | | |
| | | | | acetate | | | | | | | | |
| 51 | Ex. 12 | 100:0 | 20.5 +/− 1.5% | t-butyl | 0 | 0 | 3 | 1 | | | | |
| | | | | acetate | | | | | | | | |
| 52 | Ex. 13 | 100:0 | 20.5 +/− 1.5% | t-butyl | 0 | 0 | 2 | 5 | | | | |
| | | | | acetate | | | | | | | | |
| 53 | Ex. 14 | 100:0 | 20.5 +/− 1.5% | t-butyl | 5 | 4 | 4 | 3 | | | | |
| | | | | acetate | | | | | | | | |
| 54 | Ex. 15 | 100:0 | 20.5 +/− 1.5% | t-butyl | 2 | 0 | 5 | 5 | | | | |
| | | | | acetate | | | | | | | | |
| 55 | Ex. 16 | 100:0 | 20.5 +/− 1.5% | t-butyl | 0 | 0 | 5 | 5 | | | | |
| | | | | acetate | | | | | | | | |
| 56 | Ex. 17 | 85:15 | 20.5 +/− 1.5% | t-butyl | 2 | 0 | 2 | 0 | | | | |
| | | | | acetate | | | | | | | | |
| 57 | Ex. 18 | 85:15 | 20.5 +/− 1.5% | t-butyl | 2 | 2 | 2 | 2 | | | | |
| | | | | acetate | | | | | | | | |
| 58 | Ex. 19 | 85:15 | 20.5 +/− 1.5% | t-butyl | 4 | 4 | 5 | 3 | | | | |
| | | | | acetate | | | | | | | | |
| Comp. | Galvanized Steel Control | | | | 3 | 0 | | | | | | |
| 59 | | | | | | | | | | | | |
| Comp. | Aged Alkyd #1 Control | | | | | | 0 | 0 | | | | |
| 60 | | | | | | | | | | | | |
| 61 | Ex. 9 | 100:0 | 31.0 +/− 0.5% | t-butyl | | | | | 5 | 4 | | |
| | | | | acetate | | | | | | | | |
| 62 | Ex. 25 | 85:15 | 31.0 +/− 0.5% | t-butyl | | | | | 5 | 5 | | |
| 63 | Ex. 26 | 0:100 | 40.0 +/− 0.5% | acetate/ | | | | | 5 | 4 | | |
| | | | | EXXSOL | | | | | | | | |
| 64 | Ex. 27 | 50:50 | 20.0 +/− 0.5% | D40 | | | | | 5 | 5 | | |
| 65 | Ex. 28 | 50:50 | 31.0 +/− 0.5% | t-butyl | | | | | 5 | 5 | | |
| | | | | acetate | | | | | | | | |
| Comp. | Comparative example of Ex. 62: | | | | | | | | 0 | 0 | | |
| 66 | copolymer in the copolymer/CPO | | | | | | | | | | | |
| | blend Ex. 8 was replaced with a | | | | | | | | | | | |
| | non-IBoA/A174 contained acrylic | | | | | | | | | | | |
| | copolymer | | | | | | | | | | | |
| Comp. | Aged Alkyd #2 Control-No | | | | | | | | 0 | 1 | | |
| 67 | Copolymer No CPO | | | | | | | | | | | |
| 68 | Ex. 10 | 100:0 | 8.9 +/− 0.1% | OXSOL ® | | | | | | | 5 | 5 |
| 69 | Ex. 20 | | | 100 | | | | | | | 0 | 4 |
| 70 | Ex. 32 | 50:50 | | | | | | | | | 4 | 4 |
| 71 | Ex. 21 | 100:0 | | | | | | | | | 1 | 5 |
| 72 | Ex. 33 | 50:50 | | | | | | | | | 4 | 5 |

| | | | |
|---|---|---|---|
| Comp. | PP/TPO Control-No | 0 | 0 |
| 73 | Copolymer No CPO | | |

In view of the foregoing description and examples the present invention thus relates inter alia to the subject matter of the following clauses though being not limited thereto.

Clause 1: A resinous adhesion promoter composition comprising a random copolymer having first and second constitutional monomeric units, the first monomeric units comprising groups that promote adhesion to a substrate and the second monomeric units being derived from ethylenically unsaturated monomers and comprising other groups that promote adhesion to a substrate.

Clause 2: The composition of clause 1, wherein the first monomeric units comprise a halogen substituent and/or a pendant organic group having six or more carbon atoms.

Clause 3: The composition of clause 2, wherein the first monomeric units comprise monomeric units derived from cycloalkyl(meth)acrylate and/or aryl(meth)acrylate, preferably derived from isobornyl(meth)acrylate.

Clause 4: The composition of any of the preceding clauses, wherein the second monomeric units comprise monomeric units derived from aromatic, amino, sulfide, mercapto, uredo, organometal, or organometalloids functionalized (meth)acrylates.

Clause 5: The composition of clause 4, wherein the second monomeric units comprise an alkoxy metal or metalloid group, preferably an alkoxy silane group.

Clause 6: The composition of any of the preceding clauses, wherein the first monomeric units comprise 20-95 wt. % of the random copolymer based on the total solids weight of the random copolymer and the second monomeric units comprise 5-50 wt. % of the random copolymer based on the total solids weight of the random copolymer.

Clause 7: The composition of any of the preceding clauses, wherein the random copolymer comprises further monomeric units different from the first and second monomeric units, the further monomeric units being derived from ethylenically unsaturated monomers.

Clause 8: The composition of clause 7 wherein the further monomeric units comprise up to 25 wt. % of the random copolymer based on the total solids weight of the random copolymer.

Clause 9: The composition of any of the preceding clauses further comprising a polyolefin or a chemically modified polyolefin.

Clause 10: A method of treating a substrate comprising (1) cleaning at least a portion of a substrate, and (2) applying the resinous adhesion promoter composition of any of clauses 1-9 directly onto the cleaned portion, wherein step (2) directly follows step (1) with no steps in between.

Clause 11: The method of clause 10, wherein the substrate comprises is polymeric, ceramic, metallic and/or wooden.

Clause 12: The method of clauses 10 or 11, wherein step (a) comprises cleaning the substrate with a cleaning composition comprising a fatty acid ester.

Clause 13: The method of any of clauses 10-12, further comprising applying a second coating composition directly onto the resinous adhesion promoter composition of claim 1 or a coating layer formed therefrom.

Clause 14: The method of any of clauses 10-13, wherein the second coating composition comprises a clearcoat composition and/or a basecoat composition and/or a primer composition.

Clause 15: A substrate at least partially coated with any of the compositions of clauses 1-9.

Whereas particular aspects of this invention have been described above for purposes of illustration, it will be evident to those skilled in the art that numerous variations of the details of the present invention may be made without departing from the invention as defined in the appended claims.

The invention claimed is:

1. A resinous adhesion promoter composition comprising a random copolymer having first and second constitutional monomeric units, the first monomeric units comprising functional groups that promote adhesion to a substrate and the second monomeric units being derived from ethylenically unsaturated monomers and comprising other functional groups that promote adhesion to a substrate.

2. The composition of claim 1, wherein the first monomeric units comprise monomeric units derived from cycloalkyl(meth)acrylate and/or aryl(meth)acrylate.

3. The composition of claim 2, wherein the first monomeric units comprise 20-95 wt. % of the random copolymer based on the total solids weight of the random copolymer.

4. The composition of claim 2, wherein the first monomeric units comprise monomeric units derived from isobornyl(meth)acrylate.

5. The composition of claim 3, wherein the second monomeric units comprise an alkoxy metal or alkoxy metalloid group.

6. The composition of claim 5, wherein second monomeric units comprise an alkoxy silane group.

7. The composition of claim 6, wherein the second monomeric units comprise 5-50 wt. % of the random copolymer based on the total solids weight of the random copolymer.

8. The composition of claim 1, wherein the random copolymer comprises further monomeric units different from the first and second monomeric units, the further monomeric units being derived from ethylenically unsaturated monomers.

9. The composition of claim 8 wherein the further monomeric units comprise up to 25 wt. % of the random copolymer based on the total solids weight of the random copolymer.

10. The composition of claim 1 further comprising a polyolefin or a chemically modified polyolefin.

11. A method of treating a substrate comprising (1) cleaning at least a portion of a substrate, and (2) applying the resinous adhesion promoter composition of claim 1 directly onto the cleaned portion, wherein step (2) directly follows step (1) with no steps in between.

12. The method of claim 11, wherein the substrate comprises is polymeric, ceramic, metallic, or wood.

13. The method of claim 12, wherein the substrate is at least partially coated with an alkyd resin.

14. The method of claim 11, wherein step (a) comprises cleaning the polymeric substrate with a cleaning composition comprising a fatty acid ester.

15. The method of claim 14, wherein the resinous adhesion promoter composition further comprises a polyolefin or a chemically modified polyolefin.

16. The method of claim 11, further comprising applying a second coating composition directly onto the resinous adhesion promoter composition of claim 1 or a coating layer formed therefrom.

17. The method of claim 15, wherein the second coating composition comprises a clearcoat composition and/or a basecoat composition and/or a primer composition.

18. A substrate at least partially coated with the composition of claim 1.
